(19) United States
(12) Patent Application Publication
(10) Pub. No.: US 2015/0114119 A1
(43) Pub. Date: Apr. 30, 2015

(54) ACCELERATION SENSOR

(71) Applicant: SAMSUNG ELECTRO-MECHANICS CO., LTD., Gyeonggi-Do (KR)

(72) Inventors: Chang Hyun LIM, Gyeonggi-Do (KR); Jong Woon KIM, Gyeonggi-Do (KR); Jong Beom KIM, Gyeonggi-Do (KR); Seung Hun HAN, Gyeonggi-Do (KR); Sung Jun LEE, Gyeonggi-Do (KR)

(73) Assignee: SAMSUNG ELECTRO-MECHANICS CO., LTD., Gyeonggi-Do (KR)

(21) Appl. No.: 14/247,786

(22) Filed: Apr. 8, 2014

(30) Foreign Application Priority Data
Oct. 29, 2013 (KR) 10-2013-0129084

(51) Int. Cl. G01P 15/03

(52) U.S. Cl. CPC G01P 15/032
USPC 73/514.36

(57) ABSTRACT

Embodiments of the invention provide an acceleration sensor, including a mass body part including a first mass body and a second mass body, flexible beams coupled with the first mass body, and a support part including first support parts, which are connected to the flexible beams and are disposed to face the second mass body, and second support parts, which are coupled with the first support parts. The mass body part, the flexible beams, and the support parts are configured of a first substrate and a second substrate coupled with each other so as to be stacked, and when the mass body part is excessively displaced, the second mass body contacts the first support parts to limit the displacement of the mass body part.

### CROSS REFERENCE TO RELATED APPLICATION

This application claims the benefit of and priority under 35 U.S.C. §119 to Korean Patent Application No. KR 10-2013-0129084, entitled “Acceleration Sensor,” filed on Oct. 29, 2013, which is hereby incorporated by reference in its entirety into this application.

### BACKGROUND

1. Field of the Invention

The present invention relates to an acceleration sensor.

2. Description of the Related Art

Generally, an inertia sensor has been used for a car, an airplane, a mobile communication terminal, a toy, and the like. Meanwhile, a high-performance and small tri-axial acceleration sensor and an angular velocity sensor capable of measuring an X axis, a axis, and a Z axis has been developed so as to measure fine acceleration.

The acceleration sensor among the above-mentioned inertial sensors has technical features of converting a motion of a mass body and a flexible beam into an electrical signal and uses a piezo-resistive type that detects a motion of a mass body using a change in resistance of a piezo-resistive element disposed in a flexible beam, a capacitive type that detects a motion of a mass body using a change in capacitance between fixed electrodes, and the like.

The piezo-resistive type uses an element of which the resistance value is changed due to stress and, for example, increases a resistance value at a place where tensile stress is distributed and reduces a resistance value at a place where a compressive stress is distributed.

Further, the acceleration sensor based on the piezo-resistive type according to conventional art, for example, as described in U.S. Patent Publication No. 2006/0156818, is vulnerable to shocks at the time of reducing an area of the beam so as to increase sensitivity and has a complicated process and degraded productivity at the time of forming a stopper to prevent the mass body from being excessively displaced.

### SUMMARY

Accordingly, embodiments of the present invention provide an acceleration sensor, in which as a first substrate and a second substrate are stacked, a flexible beam is thinly formed to improve sensing sensitivity, as a stopper having rigidity is formed, a mass body part is configured to include a first mass body and a second mass body, and the second mass body is designed to be largest in a defined space, a mass is increased, and as the center of gravity is declined, sensitivity is improved.

Further, embodiments of the present invention have been made in an effort to provide an acceleration sensor capable of improving sensitivity by forming a plating layer plated with metal on a mass body part.

According to a preferred embodiment of the present invention, there is provided an acceleration sensor, including a mass body part including a first mass body and a second mass body, flexible beams coupled with the first mass body, and a support part including first support parts, which are connected to the flexible beam and are disposed to face the second mass body, and second support parts, which are coupled with the first support parts. In accordance with at least one embodiment, the mass body part, the flexible beams, and the support parts are configured of a first substrate and a second substrate, which are coupled with each other, so as to be stacked, and when the mass body part is excessively displaced, the second mass body contacts the first support parts to limit the displacement of the mass body part.

In accordance with at least one embodiment of the invention, the flexible beams are configured of the first substrate.

In accordance with at least one embodiment of the invention, the first mass body is configured of the first substrate and the second mass body is configured of the second substrate.

In accordance with at least one embodiment of the invention, a width W2 of the second mass body is formed to be larger than a width W1 of the first mass body.

In accordance with at least one embodiment of the invention, the first mass body includes a plurality of groove parts, which extend from an outer side portion thereof toward a central portion thereof at equidistance, and the flexible beams are connected to the central portion of the first mass body through the groove parts.

In accordance with at least one embodiment of the invention, the first support parts are configured of the first substrate, and the second support parts are configured of the second substrate.

In accordance with at least one embodiment of the invention, the first support parts are formed to protrude toward the first mass body based on a connection part with the second support parts.

In accordance with at least one embodiment of the invention, the first support parts are disposed on an upper portion of the second mass body to be spaced apart from each other at a predetermined interval, with respect to a stacking direction of the first substrate coupled with the second substrate.

In accordance with at least one embodiment of the invention, a thickness T2 of the first support parts is formed to be larger than a thickness T1 of the flexible beams.

In accordance with at least one embodiment of the invention, the first substrate is formed of an SOI wafer and the second substrate may be formed of a Bare wafer.

In accordance with at least one embodiment of the invention, the first substrate and the second substrate are coupled with each other by a silicon direct bonding method.

In accordance with at least one embodiment of the invention, the surface of the first substrate coupled with the second substrate is provided with a SiO₂ layer.

In accordance with at least one embodiment of the invention, the second mass body is provided with a plating layer plated with metal

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view schematically illustrating an acceleration sensor, in accordance with a preferred embodiment of the present invention.

FIG. 2 is a perspective view illustrating a mass body part in the acceleration sensor illustrated in FIG. 1 in accordance with a preferred embodiment of the present invention.

FIG. 3 is a plan view schematically illustrating the acceleration sensor illustrated in FIG. 1 in accordance with a preferred embodiment of the present invention.

FIG. 4 is a schematic cross-sectional view of the acceleration sensor illustrated in FIG. 2 taken along the line A-A, in accordance with a preferred embodiment of the present invention.

FIG. 5 is a schematic cross-sectional view of the acceleration sensor illustrated in FIG. 2 taken along the line B-B, in accordance with a preferred embodiment of the present invention.

FIG. 6 is a schematic partial enlarged view of C in the acceleration sensor illustrated in FIG. 2, in accordance with a preferred embodiment of the present invention.

FIG. 7 is a schematic use state diagram of an angular velocity sensor according to a preferred embodiment of the present invention, in accordance with a preferred embodiment of the present invention.

FIG. 8 is a schematic cross-sectional view of an acceleration sensor, in accordance with another preferred embodiment of the present invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification

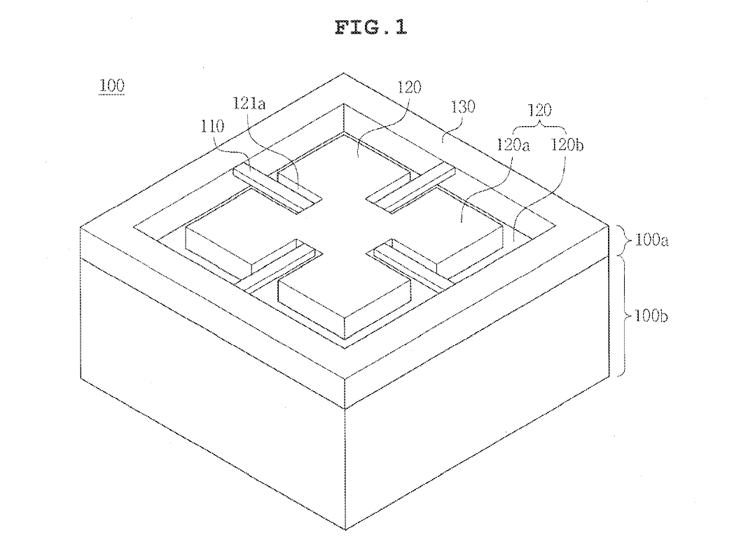

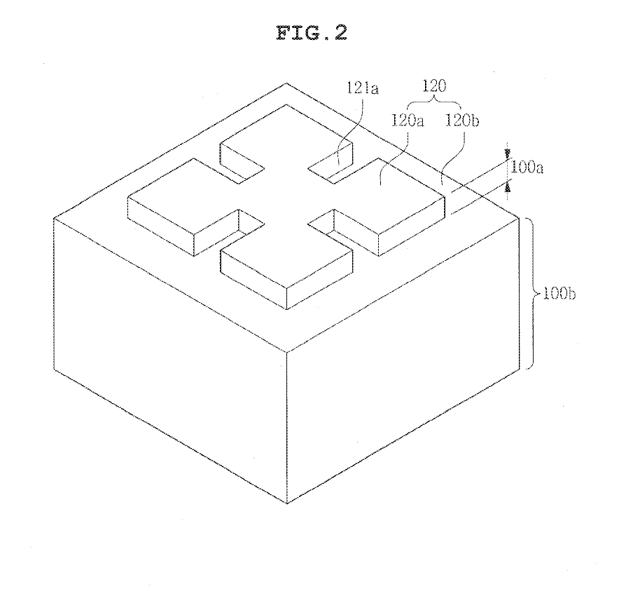

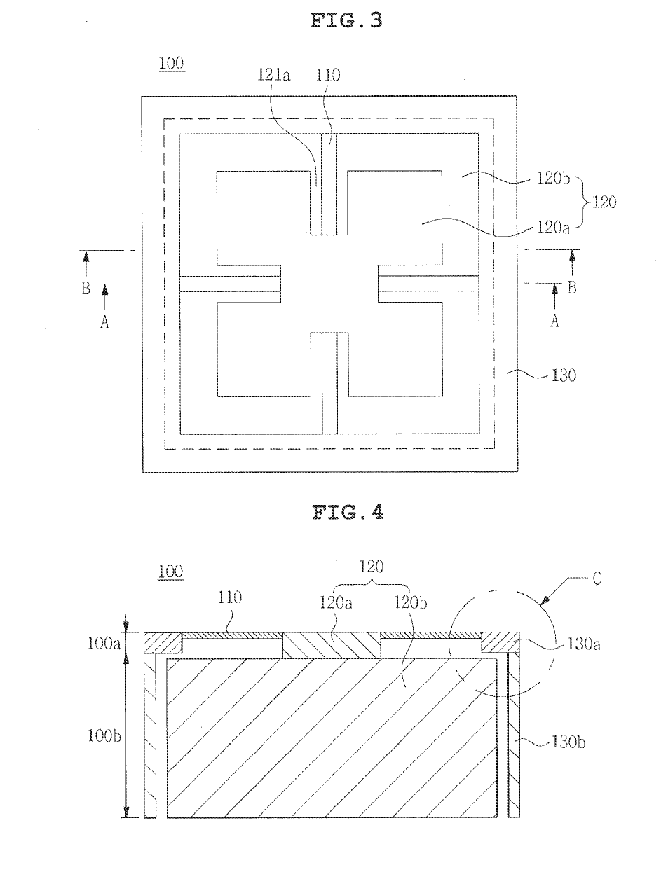

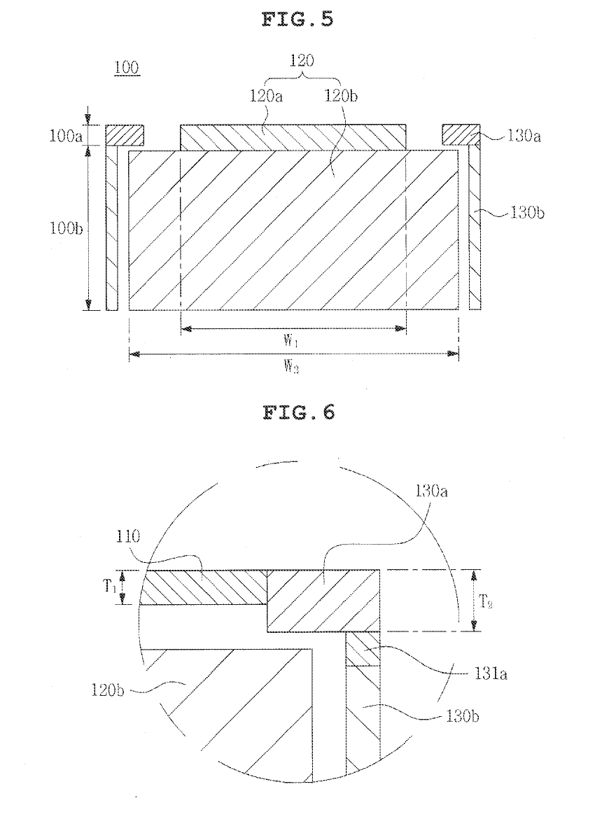

FIG. 1 is a perspective view schematically illustrating an acceleration sensor, in accordance with a preferred embodiment of the present invention, FIG. 2 is a perspective view illustrating a mass body part in the acceleration sensor illustrated in FIG. 1, in accordance with a preferred embodiment of the present invention, FIG. 3 is a plan view schematically illustrating the acceleration sensor illustrated in FIG. 1, in accordance with a preferred embodiment of the present invention, FIG. 4 is a schematic cross-sectional view of the acceleration sensor illustrated in FIG. 2 taken along the line A-A, in accordance with a preferred embodiment of the present invention, and FIG. 5 is a schematic cross-sectional view of the acceleration sensor illustrated in FIG. 2 taken along the line B-B, in accordance with a preferred embodiment of the present invention.

As illustrated in these figures, an acceleration sensor 100, in accordance with at least one embodiment of the invention, includes a flexible beam 110, a mass body part 120, and a support part 130. As shown in FIG. 1, the acceleration sensor 100, in accordance with at least one embodiment, includes four flexible beams 110. Further, the acceleration sensor 100 is formed by coupling a first substrate 100a with a second substrate 100, in which each component is formed by making patterns formed on the first substrate 100a and the second substrate 100b, respectively, different and etching the patterns, such that a freedom of design is increased and the mass body part is the largest. The detailed technical configuration thereof will be described below.

In accordance with at least one embodiment, the first substrate 100a is formed of an SOI wafer and the second substrate 100b is formed of a Bare wafer. Further, the first substrate 100a and the second substrate 100b are coupled with each other by a silicon direct bonding method.

In accordance with at least one embodiment, each component of the acceleration sensor 100 is configured of only the first substrate 100a or is configured of the first substrate 100a and the second substrate 100b.

In more detail, each flexible beam 110 is configured of the first substrate 100a, the mass body part 120 is configured of the first substrate 100a. and the second substrate 100b, and the support part 130 is configured of the first substrate 100a and the second substrate 100b.

In accordance with at least one embodiment, the mass body part 120 includes a first mass body 120a, which is configured of the first substrate 100a, and a second mass body 120b, which is configured of the second substrate 100b, and the support part 130 includes a first support part 130a, which is configured of the first substrate 100a, and a second support part 130b, which is configured of the second substrate 100b.

Hereinafter, a more detailed shape of each component and an organic coupling between the components will be described in more detail.

In accordance with at least one embodiment of the invention, the mass body part 120 is displaceably coupled with the flexible beam 110 and is displaced due to an inertial force, an external force, a Coriolis force, a driving force, and the like.

Further, the mass body part 120, in accordance with at least one embodiment, has a square pillar shape, as an example, but is not limited thereto, and may have all the shapes known in the art, such as a cylinder.

Further, as described above, the mass body part 120 includes the first mass body 120a, which is configured of the first substrate 100a, and the second mass body 120b, which is configured of the second substrate 100b.

As illustrated in. more detail in FIG. 2, the first mass body 120a is provided with four groove parts 121a at equidistance, so that the first mass body 120a is each connected to the flexible beams 110 in all directions, and has a rectangular parallelepiped shape. Thus, the four groove parts 121a are formed to extend from an outer side portion of the first mass body 120a toward a central portion thereof, so that a central portion of the mass body part 120 is fixed to be displaced by the flexible beams 110 and the central portion of the first mass body 120a is coupled with each of the four flexible beams 110 in all directions.

Further, in accordance with at least one embodiment of the invention, the second mass body 120b is coupled with the first mass body 120a, and as described above, is configured of the second substrate 100b. Further, the second mass body 120b is formed to be larger than the first mass body 120a to increase a mass of the mass body part 120 and form the center of gravity on a lower portion of the mass body part 120 and is disposed to be adjacent to the support part 130.

As illustrated in FIG, 5, a width W2 of the second mass body 120b is formed to be larger than a width W1 of the first mass body 120a, thereby maximizing the size of the mass body part 120.

Further, as described above, the mass body part 120, in accordance with at least one embodiment, is formed to be the largest by the shape of the second mass body 120b.

Next, in accordance with at least one embodiment of the invention, each of the flexible beams 110 has a plate shape and is configured of a flexible substrate, such as a membrane and a beam having elasticity to displace the mass body part 120. Further, as described above, each of the flexible beams 110 is configured of only the first substrate 100a. In addition, one end of each flexible beam 110 is connected to the central portion of the first mass body 120a through the groove part 121a and the other end thereof is connected to the support part 130.

Further, one surface of each flexible beam 110 is provided with a detection unit or detector (not illustrated) (hereinafter collectively referred to as a detection unit) for detecting the displacement of the mass body, in which the detection unit is variously made of a piezoelectric material, a piezo-resistive material, and the like.

In accordance with at least one embodiment, the support part 130 is coupled with a respective flexible beam 110, which is coupled with the mass body part 120 and supports the mass body part 120 to be floated, and at the same time has a hollow shape to displace the mass body part 120, thereby securing a space in which the mass body part 120 is displaced.

Further, as described above, the support part 130 includes a first support part 130a, which is configured of the first substrate 100a, and a second support part 130b, which is configured of the second substrate 100b. Further, the first support part 130a is connected to the flexible beam 110.

Further, the first support part 130a is formed to protrude toward the first mass body 120a based on a connection part with the second support part 130b. To this end, as a pattern difference is formed on the first substrate 100a and the second substrate 100b and each of the flexible beams 110 is formed by forming a step on the first substrate 100a, the flexible beam 110, which is a thin beam part which improves sensitivity and the first support part 130a, which is a stopper part having the secured rigidity, is simultaneously formed.

As illustrated in FIG. 6, as a thickness T2 of the first support part 130a is formed to be larger than a thickness T1 of the flexible beam 110, the thin beam and the thick stopper are simultaneously implemented.

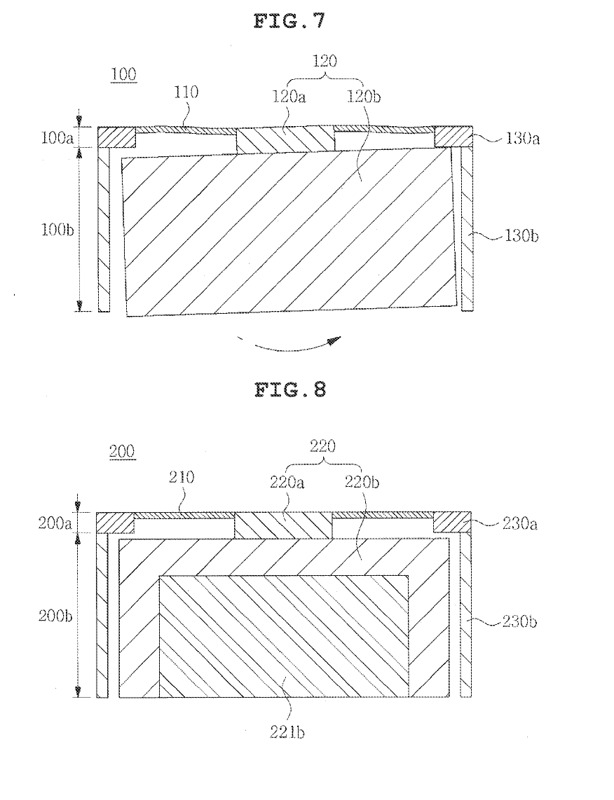

Further, in accordance with at least one embodiment, an end of the second mass body 120b is formed to be disposed at a lower portion of the first support part 130a Therefore, as illustrated in FIG. 7, when the mass body part 120 is excessively displaced, the displacement of the second mass body 120b is limited by contacting the first support part 130a and the first support part 130a serves as the stopper.

Further, as described above, the first substrate 100a and the second substrate 100b are coupled with each other by the silicon direct bonding method. The reason is that when the first substrate 100a and the second substrate 100b are coupled with each other by a polymer bonding method, it is difficult to limit dispersion and it is difficult to implement a precise bonding.

FIG. 6 is a schematic partial enlarged view of C in the acceleration sensor illustrated in FIG. 2, in accordance with a preferred embodiment of the present invention. As illustrated, the first substrate 100a is provided with a SiO₂ layer 131a and an interval between the second mass body 120b and the first support part 130a is precisely formed by controlling the thickness of the SiO₂ layer 131a.

Further, the acceleration sensor 100 according to the preferred embodiment of the present invention is configured to further include a lower cover (not illustrated), which is coupled with the second support part 130b to cover the mass body part 120 and an upper cover (not illustrated), which is coupled with one surface of the support part 130 to cover a respective flexible beam 110.

In the acceleration sensor according to the conventional art, the upper cover performs a function of the stopper, which limits the displacement of the mass body part, while in the acceleration sensor according to the preferred embodiment of the present invention, the first support part performs the function of the stopper, such that there is no need to form the stopper on the upper cover.

Further, each of the flexible beams 110 is further provided with the sensing unit or sensor (hereinafter collectively referred to as a “sensing unit”), which senses the displacement of the mass body part and the sensing unit is variously made of a piezoelectric material, a piezo-resistive material, and the like.

In accordance with at least one embodiment of the invention, the lower cover is coupled with the lower portion of the second support part to cover the mass body part.

Next, to form each component, the acceleration sensor 100 according to the preferred embodiment of the present invention is formed, so that the masking patterns formed on the first substrate and the second substrate remain in the residual structure of the acceleration sensor 100.

By the above structure, in the acceleration sensor 100 according to the preferred embodiment of the present invention, each of the flexible beams 110 is thinly formed to improve the sensing sensitivity, as the reliable stopper is formed by the first support part 130a having rigidity, the mass body part 120 is configured to include the first mass body 120a and the second mass body 120b, and the second mass body 120b is designed to be the largest in the defined space, the mass is increased, and as the center of gravity is declined, the sensitivity is improved.

FIG. 8 is a schematic cross-sectional view of an acceleration sensor, in accordance with another preferred embodiment of the present invention. As illustrated, an acceleration sensor 200 according to another preferred embodiment of the present invention is different from only the mass body part, comparing with the acceleration sensor 100 according to the preferred embodiment of the present invention illustrated in FIG. 4.

In more detail, the mass body part 220 includes a first mass body 220a, which is configured of a first substrate 200a, and a second mass body 220b, which is configured of a second substrate 200b.

Further, at the time of forming the second substrate 100b, a plating layer 221b is formed corresponding to the second mass body part 220b by plating a high-density metal by a plating method, and the like.

Further, other components of the acceleration sensor 200 are the same as the components corresponding to the acceleration sensor 100 according to the preferred embodiment of the present invention and therefore the detailed description thereof will be omitted.

By the above structure, the mass body part 200 is provided with the plating layer of metal without additionally increasing the size to increase the weight, such that the center of gravity of the mass body part 200 may be formed at the lower portion thereof, thereby improving the sensitivity.

Further, FIG. 8 illustrates an example in which the plating layer is formed and the plating layer is also formed at the upper and side portions of the mass body part.

By the above structure, when the second mass body contacts the first support part serving as the stopper part depending on the excessive displacement of the mass body part, the plating layer of metal covers the second mass body to be able to prevent the reduction in sensing reliability depending on the damage of the second mass body.

According to the preferred embodiments of the present invention, it is possible to obtain the acceleration sensor, in which as the first substrate and the second substrate are stacked, the flexible beam may be thinly formed to improve the sensing sensitivity, as the stopper having rigidity is formed, the mass body part is configured to include the first mass body and the second mass body, and the second mass body is designed to be largest in the defined space, the mass may be increased, and as the center of gravity is declined, the sensitivity may be improved. Further, according to the preferred embodiments of the present invention, it is possible to obtain the acceleration sensor capable of improving the sensitivity by forming the plating layer plated with metal on the mass body part.

Terms used herein are provided to explain embodiments, not limiting the present invention. Throughout this specification, the singular tuna includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method be or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An acceleration sensor, comprising:
a mass body part comprising a first mass body and a second mass body;
flexible beams coupled with the first mass body; and
a support part comprising first support parts, which are connected to the flexible beams and are disposed to face the second mass body, and second support parts, which are coupled with the first support parts,
wherein the mass body part, the flexible beams, and the support parts are configured of a first substrate and a second substrate, which are coupled with each other so as to be stacked, and
wherein, when the mass body part is excessively displaced, the second mass body contacts the first support parts to limit the displacement of the mass body part.

2. The acceleration sensor as set forth in claim 1, wherein the flexible beams are configured of the first substrate.

3. The acceleration sensor as set forth in claim L wherein the first mass body is configured of the first substrate, and the second mass body is configured of the second substrate.

4. The acceleration sensor as set forth in claim 3, wherein a width W2 of the second mass body is formed to be larger than a width W1 of the first mass body.

5. The acceleration sensor as set forth in claim 3, wherein the first mass body comprises a plurality of groove parts, which extend from an outer side portion thereof toward a central portion thereof at equidistance, and the flexible beam is connected to the central portion of the first mass body through the groove parts.

6. The acceleration sensor as set forth in claim 1, wherein the first support parts are configured of the first substrate and the second support parts are configured of the second substrate.

7. The acceleration sensor as set forth in claim 6, wherein the first support parts are formed to protrude toward the first mass body based on a connection part with the second support parts.

8. The acceleration sensor as set forth in claim 7, wherein the first support parts are disposed on an upper portion of the second mass body to be spaced apart from each other at a predetermined interval, with respect to a stacking direction of the first substrate coupled with the second substrate.

9. The acceleration sensor as set forth in claim 1, wherein a thickness T2 of the first support parts are formed to be larger than a thickness T1 of the flexible beams.

10. The acceleration sensor as set forth in claim 1, wherein the first substrate is formed of an SOI wafer and the second substrate is formed of a Bare wafer.

11. The acceleration sensor as set forth in claim 10, wherein the first substrate and the second substrate are coupled with each other by a silicon direct bonding method.

12. The acceleration sensor as set forth in claim 6, wherein one surface of the first substrate coupled with the second substrate is provided with a SiO₂ layer.

13. The acceleration sensor as set forth in claim 1, wherein the second mass body is provided with a plating layer plated with metal.
